(19) United States
(12) Patent Application Publication
(10) Pub. No.: US 2012/0073943 A1
(43) Pub. Date: Mar. 29, 2012

(54) KEYSWITCH AND KEYBOARD

(76) Inventor: Yang-Shu Tseng, Taoyuan (TW)

(21) Appl. No.: 13/237,941

(22) Filed: Sep. 21, 2011

(30) Foreign Application Priority Data
Sep. 28, 2010 (TW) 099218704

(51) Int. Cl. H01H 13/76; H01H 1/10

(52) U.S. Cl. 200/5 A; 200/517

(57) ABSTRACT

A keyswitch includes a base, a circuit board, a film, a resilient member, a support member and a key cap. The circuit board is disposed on the base and has a switch. The film is disposed on the circuit board. The resilient member is fixed on the film and opposite to the switch on the circuit board. The support member is disposed on the film and has a driving portion, wherein the driving portion is opposite to the resilient member. The key cap is disposed on the support member. When the key cap is pressed, the driving portion drives the resilient portion to trigger the switch.

### BACKGROUND OF THE INVENTION

1. Field of the Invention

The invention relates to a keyswitch and a keyboard and, more particularly, to a keyswitch adapted to a slim keyboard.

2. Description of the Prior Art

A keyboard, which is the most common input device, can be found in variety of electronic equipments for users to input characters, symbols, numerals and so on. From consumer electronic products to industrial machine tools are all equipped with a keyboard for purpose of operation.

Referring to FIG. 1, FIG. 1 is a cross-sectional view illustrating a keyswitch 1 of the prior art. As shown in FIG. 1, the keyswitch 1 comprises a base 10, a key cap 12, a circuit board 14, a lift support device 16 and a resilient member 18. The circuit board 14 is disposed on the base 10. The lift support device 16 is disposed between the key cap 12 and the base 10 and used for supporting the key cap 12. The resilient member 18 is also disposed between the key cap 12 and the base 10. When the key cap 12 is pressed by a user, the resilient member provides an elastic force for the key cap 12 so as to make the key cap 12 return to the original position.

As shown in FIG. 1, the key cap 12 has a first sliding groove 120 and a first engaging groove 122, the base 10 has a second sliding groove 100 and a second engaging groove 102, and the lift support device 16 comprises a first support member 160 and a second support member 162. One end of the first support member 160 is slidably disposed in the first sliding groove 120 and the other end of the first support member 160 is pivotally disposed in the second engaging groove 102. One end of the second support member 162 is slidably disposed in the second sliding groove 100 and the other end of the second support member 162 is pivotally disposed in the first engaging groove 122. Accordingly, the key cap 12 can move toward the base 10 along with the lift support device 16. However, the aforesaid mechanism of the conventional lift support device 16 will increase height of the keyswitch 1, such that the conventional keyswitch 1 cannot be adapted to a slim keyboard.

### SUMMARY OF THE INVENTION

Therefore, an objective of the invention is to provide a keyswitch, which is adapted to a slim keyboard.

According to an embodiment, a keyswitch of the invention comprises a base, a circuit board, a film, a resilient member, a support member and a key cap. The circuit board is disposed on the base and has a switch. The film is disposed on the circuit board. The resilient member is fixed on the film and opposite to the switch on the circuit board. The support member is disposed on the film and has a driving portion, wherein the driving portion is opposite to the resilient member. The key cap is disposed on the support member. When the keycap is pressed, the driving portion drives the resilient portion to trigger the switch and the resilient member provides an elastic force for the key cap. When the external force is released from the key cap, the elastic force provided by the resilient member can make the key cap return to the original position.

Another objective of the invention is to provide a keyboard, which comprises a base, a circuit board, a film and a plurality of keyswitches. The structure of one of the keyswitches of the keyboard is mentioned in the above.

As mentioned in the above, the invention utilizes the support member to support the key cap and utilizes the resilient member to provide the elastic force for the key cap. When the key cap is pressed, the invention utilizes the driving portion of the support member to drive the resilient member to trigger the switch. In other words, the invention replaces the conventional lift support device by the support member so as to reduce the volume of the keyswitch and keyboard. Accordingly, the keyswitch of the invention can be adapted to a slim keyboard.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a cross-sectional view illustrating a keyswitch of the prior art.

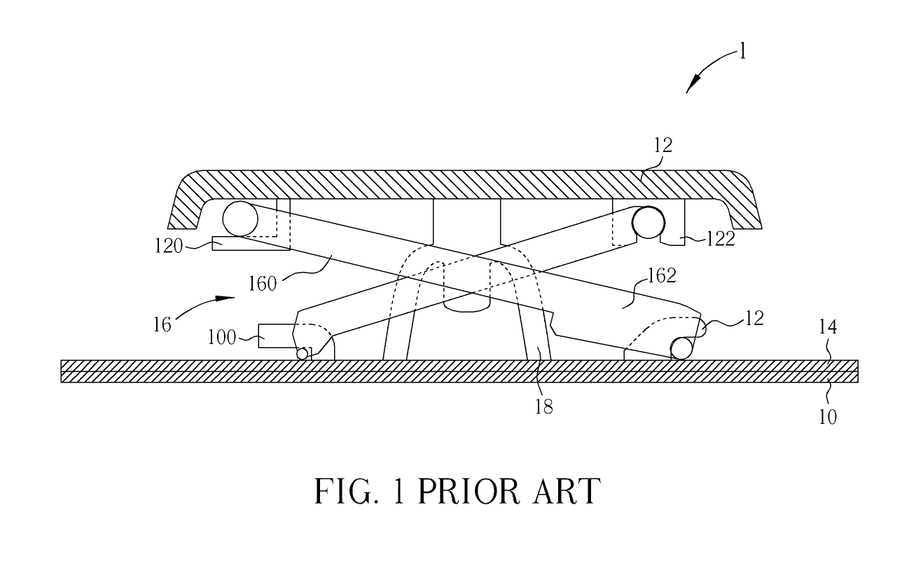

FIG. 2 is a schematic diagram illustrating a keyboard according to an embodiment of the invention.

FIG. 3 is a cross-sectional view illustrating one of the keyswitches shown in FIG. 2 along line X-X.

FIG. 4 is an exploded view illustrating the keyswitch shown in FIG. 3.

FIG. 5 is a perspective view illustrating the support member shown in FIG. 4 from another view angle.

### DETAILED DESCRIPTION

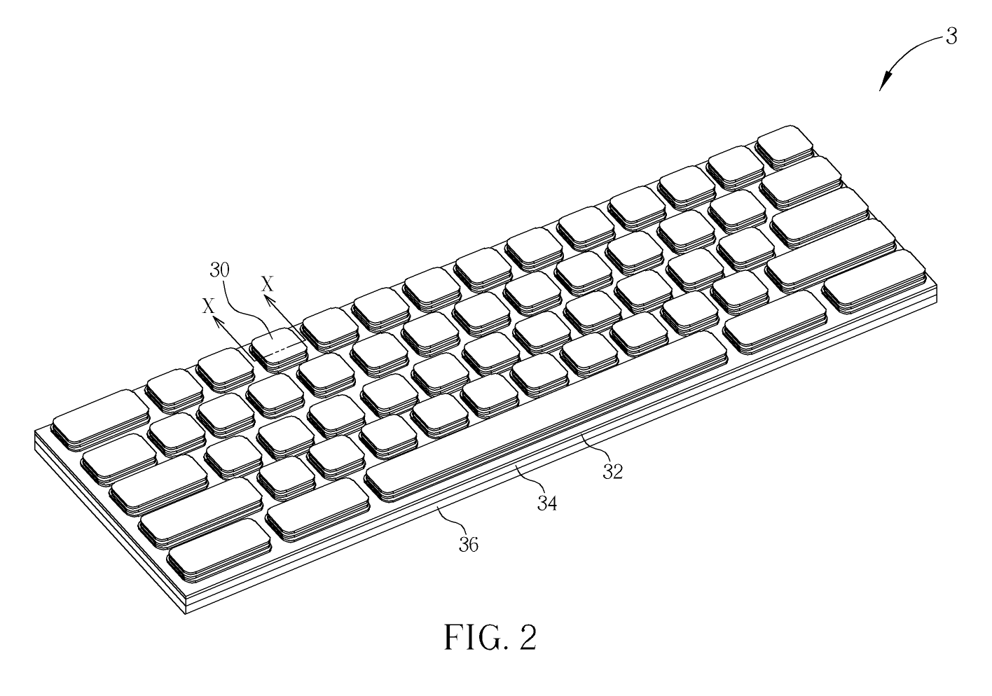

Referring to FIG. 2, FIG. 2 is a schematic diagram illustrating a keyboard 3 according to an embodiment of the invention. As shown in FIG. 2, the keyboard 3 comprises a plurality of keyswitches 30, a film 32, a circuit board 34 and a base 36. The keyswitches 30, the film 32 and the circuit board 34 are disposed on the base 36. The keyswitches 30 are used for a user to press so as to execute desired function correspondingly. In this embodiment, the keyboard 3 may be, but not limited to, a slim keyboard and the keyswitches 30 may be, but not limited to, slim keyswitches.

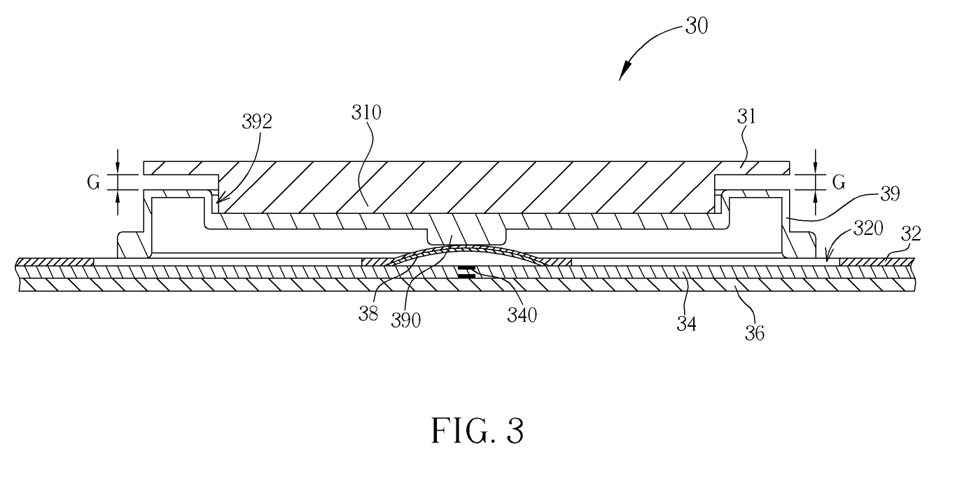

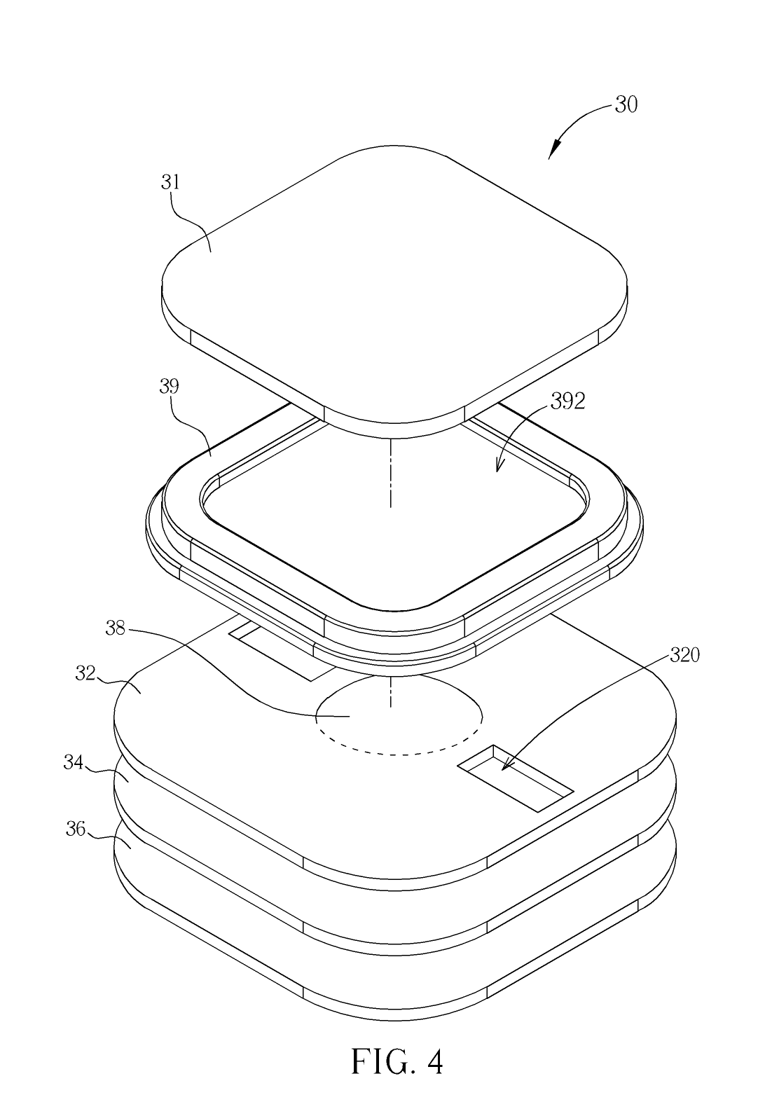

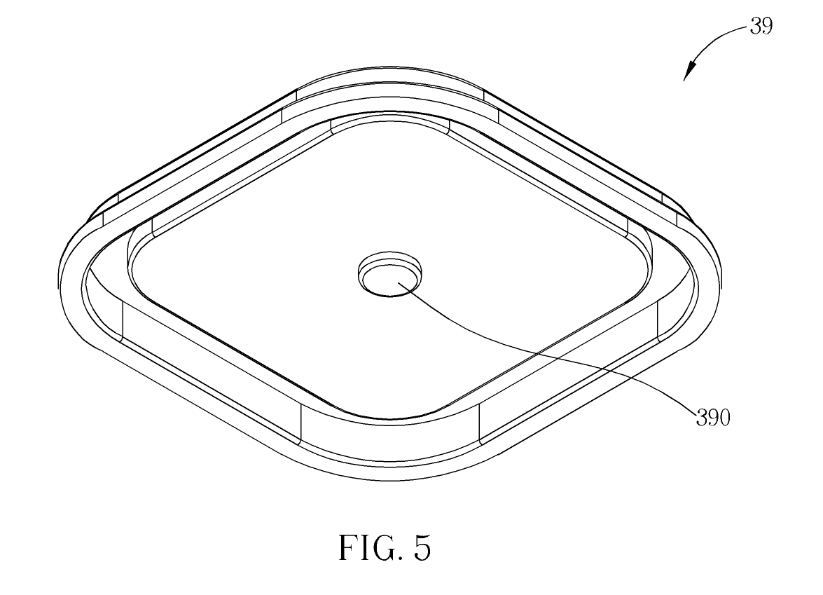

Referring to FIGS. 3 to 5, FIG. 3 is a cross-sectional view illustrating one of the keyswitches 30 shown in FIG. 2 along line X-X, FIG. 4 is an exploded view illustrating the keyswitch 30 shown in FIG. 3, and FIG. 5 is a perspective view illustrating the support member 39 shown in FIG. 4 from another view angle. As shown in FIGS. 3 and 4, the keyswitch 30 comprises a key cap 31, a film 32, a circuit board 34, a base 36, a resilient member 38 and a support member 39. The circuit board 34 is disposed on the base 36 and has a switch 340. The film 32 is disposed on the circuit board 34. The resilient member 38 is fixed on the film 32 and opposite to the switch 340. The support member 39 is disposed on the film 32. As shown in FIGS. 4 and 5, the support member 39 has a driving portion 390 and the driving portion 390 is opposite to the resilient member 38. The key cap 31 is disposed on the support member 39. In this embodiment, the circuit board 34 maybe a membrane circuit board, a flexible circuit board or a printed circuit board; the resilient member 38 may be a metal dome; and the support member 39 may be a rubber dome.

When the key cap 31 is pressed, the driving portion 390 of the support member 39 drives the resilient member 38 to move toward the base 36 so as to trigger the switch 340 on the circuit board 34. At this time, the resilient member 38 provides an elastic force for the key cap 31. When the external force is released from the key cap 31, the elastic force provided by the resilient member 38 can make the support member 39 and the key cap 31 return to the original position.

In this embodiment, the key cap has a protrusion 310 and the support member 39 has a recess 392. The key cap 31 can be aligned with the support member 39 using assembling tool so as to dispose the protrusion 310 of the key cap 31 in the recess 392 of the support member 39 and then the key cap 31 can be adhered to the support member 39 using adhesive. It should be noted that the support member 39 and the key cap 31 of the invention can be also formed integrally. For example, the key cap 31 and the support member 39 of the invention can be formed integrally by double injection molding or in-mold injection molding.

As shown in FIG. 3, a gap G is between a side of the key cap 31 and a side of the support member 39. When a user only presses the side of the key cap 31, the gap G can make the press more smoothly. Furthermore, in this embodiment, two exhaust holes 320 are formed on the film 32. When the keycap 31 is pressed, air between the support member 39 and the film 32 is exhausted through the exhaust holes 320, so as to prevent the air between the support member 39 and the film 32 from generating resistance while the user presses the key cap 31.

Compared to the prior art, the invention utilizes the support member to support the key cap and utilizes the resilient member to provide the elastic force for the key cap. When the key cap is pressed, the invention utilizes the driving portion of the support member to drive the resilient member to trigger the switch. In other words, the invention replaces the conventional lift support device by the support member so as to reduce the volume of the keyswitch and keyboard. Accordingly, the keyswitch of the invention can be adapted to a slim keyboard.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A keyswitch comprising:
a base;
a circuit board disposed on the base, the circuit board having a switch;
a film disposed on the circuit board;
a resilient member fixed on the film, the resilient member being opposite to the switch on the circuit board;
a support member disposed on the film, the support member having a driving portion, the driving portion being opposite to the resilient member; and
a key cap disposed on the support member;
wherein when the key cap is pressed, the driving portion drives the resilient portion to trigger the switch.

2. The keyswitch of claim 1, wherein the circuit board is one selected from a group consisting of a membrane circuit board, a flexible circuit board and a printed circuit board.

3. The keyswitch of claim 1, wherein the resilient member is a metal dome.

4. The keyswitch of claim 1, wherein the support member is a rubber dome.

5. The keyswitch of claim 1, wherein the key cap and the support member are formed integrally.

6. The keyswitch of claim 1, wherein the key cap has a protrusion, the support member has a recess, and the protrusion is disposed in the recess.

7. The keyswitch of claim 1, wherein a gap is between a side of the key cap and a side of the support member.

8. The keyswitch of claim 1, wherein an exhaust hole is formed on the film, when the key cap is pressed, air between the support member and the film is exhausted through the exhaust hole.

9. A keyboard comprising:
a base;
a circuit board disposed on the base, the circuit board having a switch;
a film disposed on the circuit board; and
a plurality of keyswitches, one of the keyswitches comprising:
a resilient member fixed on the film, the resilient member being opposite to the switch on the circuit board;
a support member disposed on the film, the support member having a driving portion, the driving portion being opposite to the resilient member; and
a key cap disposed on the support member;
wherein when the key cap is pressed, the driving portion drives the resilient portion to trigger the switch.

10. The keyboard of claim 9, wherein the circuit board is one selected from a group consisting of a membrane circuit board, a flexible circuit board and a printed circuit board.

11. The keyboard of claim 9, wherein the resilient member is a metal dome.

12. The keyboard of claim 9, wherein the support member is a rubber dome.

13. The keyboard of claim 9, wherein the key cap and the support member are formed integrally.

14. The keyboard of claim 9, wherein the key cap has a protrusion, the support member has a recess, and the protrusion is disposed in the recess.

15. The keyboard of claim 9, wherein a gap is between a side of the key cap and a side of the support member.

16. The keyboard of claim 9, wherein an exhaust hole is formed on the film, when the key cap is pressed, air between the support member and the film is exhausted through the exhaust hole.
